(19) United States
(12) Patent Application Publication
(10) Pub. No.: US 2020/0244842 A1
(43) Pub. Date: Jul. 30, 2020

(54) VIDEO PROCESSING METHOD AND DEVICE, UNMANNED AERIAL VEHICLE, AND COMPUTER-READABLE STORAGE MEDIUM

(71) Applicant: SZ DJI TECHNOLOGY CO., LTD., Shenzhen (CN)

(72) Inventors: Jin XIAO, Shenzhen (CN); Zisheng CAO, Shenzhen (CN); Pan HU, Shenzhen (CN)

(21) Appl. No.: 16/829,960

(22) Filed: Mar. 25, 2020

Related U.S. Application Data
(63) Continuation of application No. PCT/CN2017/106735, filed on Oct. 18, 2017.

(51) Int. Cl. H04N 5/217; H04N 5/213; B64C 39/02; G06N 3/08; G06T 5/00; G06F 17/16

(52) U.S. Cl. CPC H04N 5/217; H04N 5/213; B64C 39/024; G06N 3/08; B64C 2201/127; G06F 17/16; G06T 2207/10016; G06T 2207/20182; G06T 2207/20084; G06T 5/002

(57) ABSTRACT

Video processing method and device, unmanned aerial vehicle and computer-readable medium are provided. The method includes: providing a neural network trained based on a training set of the neural network having a first training video and a second training video, the first training video including at least one first time-space domain cube, the second training video including a first training video at least one second time-space domain cube; inputting a first video into the neural network, the first video containing certain noise; performing a denoising processing on the first video by using the neural network to generate a second video, the second video being the first video with the certain noise substantially removed; and outputting the second video.

### CROSS-REFERENCES TO RELATED APPLICATIONS

This application is a continuation of International Patent Application No. PCT/CN2017/106735, filed on Oct. 18, 2017, the entire contents of which are hereby incorporated by reference.

### FIELD OF THE DISCLOSURE

The present disclosure generally relates to the field of unmanned aerial vehicle and, more particularly, relates to a video processing method and device, an unmanned aerial vehicle (UAV) and a computer-readable storage medium.

### BACKGROUND

With the popularization of digital products such as cameras and webcams, videos have been widely used in our daily life. But noise is still inevitable during video shooting, and noise directly affects the quality of a video.

In order to remove noise from a video, methods for denoising a video include a video denoising method based on motion estimation, and a video denoising method without motion estimation. However, the computational complexity of the video denoising method based on motion estimation is often high, and the denoising effect of the video denoising method without motion estimation is often not ideal.

In order to improve the video denoising effect, a video processing method and device, a UAV, and a computer-readable storage medium are provided in the present disclosure.

### BRIEF SUMMARY OF THE DISCLOSURE

One aspect of the present disclosure provides a video processing method. The method includes: providing a neural network trained based on a training set of the neural network having a first training video and a second training video, the first training video including at least one first time-space domain cube, the second training video including a first training video at least one second time-space domain cube; inputting a first video into the neural network, the first video containing certain noise; performing a denoising processing on the first video by using the neural network to generate a second video, the second video being the first video with the certain noise substantially removed; and outputting the second video.

Another aspect of the present disclosure provides a video processing device. The video processing device includes one or more processors, individually or in cooperation used to perform: providing a neural network trained based on a training set of the neural network having a first training video and a second training video, the first training video including at least one first time-space domain cube, the second training video including a first training video at least one second time-space domain cube; inputting a first video into the neural network, the first video containing certain noise; performing a denoising processing on the first video by using the neural network to generate a second video, the second video being the first video with the certain noise substantially removed; and outputting the second video.

Another aspect of the present disclosure provides a UAV. The UAV includes a fuselage, a power system mounted on the fuselage for providing flight power; and a video processing device provided by the present disclosure.

Another aspect of the present disclosure provides a non-transitory computer-readable storage medium storing computer-executable instructions executable by one or more processors to perform: providing a neural network trained based on a training set of the neural network having a first training video and a second training video, the first training video including at least one first time-space domain cube, the second training video including a first training video at least one second time-space domain cube; inputting a first video into the neural network, the first video containing certain noise; performing a denoising processing on the first video by using the neural network to generate a second video, the second video being the first video with the certain noise substantially removed; and outputting the second video.

Other aspects or embodiments of the present disclosure can be understood by those skilled in the art in light of the description, the claims, and the drawings of the present disclosure.

### BRIEF DESCRIPTION OF THE DRAWINGS

In order to more clearly explain the embodiments of the present disclosure, the drawings used in the description of the embodiments will be briefly introduced below. Obviously, the drawings in the following description are some embodiments of the present disclosure. For those skilled in the art, other drawings can be acquired based on these drawings without creative efforts.

FIG. 1 illustrates a flow chart of an exemplary video processing method consistent with various disclosed embodiments of the present disclosure;

FIG. 2 illustrates a schematic diagram of a first training video consistent with various disclosed embodiments of the present disclosure;

FIG. 3 illustrates a decomposition diagram of image frames in a first training video consistent with various disclosed embodiments of the present disclosure;

FIG. 4 illustrates a division diagram of an exemplary first time-space domain cube consistent with various disclosed embodiments of the present disclosure;

FIG. 5 illustrates a division diagram of another exemplary first time-space domain cube consistent with various disclosed embodiments of the present disclosure;

FIG. 6 illustrates a schematic diagram of a first training video being divided into a plurality of first time-space domain cubes consistent with various disclosed embodiments of the present disclosure;

FIG. 7 illustrates a flow chart of another exemplary video processing method consistent with various disclosed embodiments of the present disclosure;

FIG. 8 illustrates a flow chart of yet another exemplary video processing method consistent with various disclosed embodiments of the present disclosure;

FIG. 9 illustrates a schematic diagram of an exemplary first mean image consistent with various disclosed embodiments of the present disclosure;

FIG. 10 illustrates a schematic diagram of an exemplary sparse processing of a first time-space domain cube consistent with various disclosed embodiments of the present disclosure;

FIG. 11 illustrates a flow chart of another exemplary video processing method consistent with various disclosed embodiments of the present disclosure;

FIG. 12 illustrates a flow chart of another exemplary video processing method consistent with various disclosed embodiments of the present disclosure;

FIG. 13 illustrates a flow chart of a video processing device consistent with various disclosed embodiments of the present disclosure; and

FIG. 14 illustrates a schematic diagram of an unmanned aerial vehicle consistent with various disclosed embodiments of the present disclosure.

### REFERENCE NUMERAL LIST

20—first training video, 21—image frame, 22—image frame, 23—image frame, 24—image frame, 25—image frame, 2n—image frame, 211—sub-image, 212—sub-image, 213—sub-image, 214—sub-image, 221—sub-image, 222—sub-image, 223—sub-image, 224—sub-image, 231—sub-image, 232—sub-image, 233—sub-image, 234—sub-image, 241—sub-image, 242 sub-image, 243—sub-image, 244—sub-image, 251—sub-image, 252—sub-image, 253—sub-image, 254—sub-image, 2n1—sub-image, 2n2—sub-image, 2n3—sub-image, 2n4—sub-image, 41—first time-space domain cube, 42—first time-space domain cube, 43—first time-space domain cube, 44—first time-space domain cube, 51—sub-image, 52—sub-image, 53—sub-image, 54—sub-image, 55—sub-image, 56—sub-image, 57—sub-image, 58—sub-image, 59—sub-image, 60—sub-image, 61—first time-space domain cube, 62—first time-space domain cube, 90—first mean image, 510—sub-image, 530—sub-image, 550—sub-image, 570—sub-image, 590—sub-image, 130—video processing device, 131—One or more processors, 100—UAV, 107—motor, 106—propeller, 117—electronic speed control, 118—flight controller, 108—sensor system, 110—communication system, 102—supporting device, 104—photographic device, 112—ground station, 114—antenna, 116—electromagnetic wave, and 109—video processing device.

### DETAILED DESCRIPTION

The technical solutions in the embodiments of the present disclosure will be described below with reference to the accompanying drawings in the embodiments of the present disclosure. Obviously, the described embodiments are part of the embodiments of the present disclosure, but not all the embodiments. Based on the disclosed embodiments of the present disclosure, other embodiments acquired by those skilled in the art without creative efforts shall fall within the protection scope of the present disclosure.

It should be noted that when a component is called “fixed to” another component, it may be directly on another component or it may exist within another component. When a component is called “connected” to another component, it may be directly connected to another component or it may exist within another component at a same time.

Unless defined otherwise, all technical and scientific terms used herein have a same meaning as commonly understood by those skilled in the art. The terms used herein in the description of the present disclosure are only for the purpose of describing specific embodiments and are not intended to limit the present disclosure. The term “and/or” used herein includes any and all combinations of one or more of the associated listed items.

Some embodiments of the present disclosure will be described in detail in the following with reference to the drawings. In the case of no conflict, the following embodiments and features in the embodiments can be combined with each other.

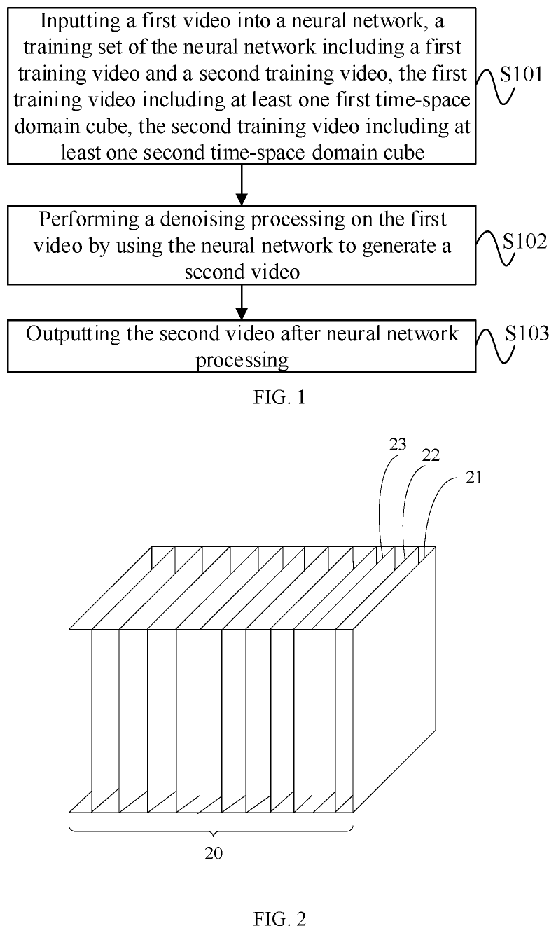

FIG. 1 illustrates a flow chart of an exemplary video processing method consistent with various disclosed embodiments of the present disclosure. The execution entity may be a video processing device, and the video processing device may be included or integrated in a UAV or a ground station. The ground station may be a remote controller, a smartphone, a tablet computer, a ground control station, or a laptop, a watch, a bracelet, etc., and any combination thereof. In other embodiments, the video processing device can also be directly included in a video-shooting device, such as a handheld gimbal, a digital camera, a video camera, etc. Specifically, if a video processing device is set on a UAV, the video processing device can process videos captured by the shooting device mounted on the UAV. If the video processing device is set at the ground station, the ground station can receive video data wirelessly transmitted by the UAV, and the video processing device processes the video data received by the ground station. Or, a user holds a shooting device, and the video processing device in the shooting device processes videos captured by the shooting device. Specific application scenarios are not limited herein. The video processing method is described in detail below.

In one embodiment, the video processing method shown in FIG. 1 may include the following steps.

S101: inputting a first video into a neural network, a training set of the neural network including a first training video and a second training video, the first training video including at least one first time-space domain cube, the second training video including at least one second time-space domain cube.

In one embodiment, the first video may be a video shot by a shooting device equipped with a UAV, or a video shot by a ground station such as a smartphone, a tablet computer, or a shooting device held by a user such as a handheld gimbal, a digital camera, a camcorder, etc. The first video is a video with noise, and the video processing device needs to perform a denoising processing on the first video. Specifically, the video processing device inputs the first video into a previously trained neural network. That is, before the video processing device inputs the first video into a neural network, the neural network has been trained according to the first training video and the second training video. The process of the training of the neural network according to the first training video and the second training video will be described in detail in the subsequent embodiments. The training set of the neural network is described in detail below.

The training set of the neural network includes a first training video and a second training video. The first training video includes at least one first time-space domain cube. The second training video includes at least one second time-space domain cube.

Optionally, the first training video is a noise-free or clean video, and the second training video is a noisy video. Specifically, the first training video can be an uncompressed HD video, and the second training video can be a video with noise added to the uncompressed HD video.

Specifically, the first time-space domain cube includes a plurality of first sub-images. The plurality of first sub-images are from a plurality of adjacent first video frames in the first training video. One first sub-image is from one first video frame. Each first sub-image has a same position in the first video frame.

As shown in FIG. 2, the reference numeral 20 represents a first training video. The first training video 20 includes a plurality of image frames. The number of image frames included in the first training video 20 is not limited. As shown in FIG. 2, image frame 21, Image frame 22, image frame 23 are just any three adjacent frames in the first training video 20.

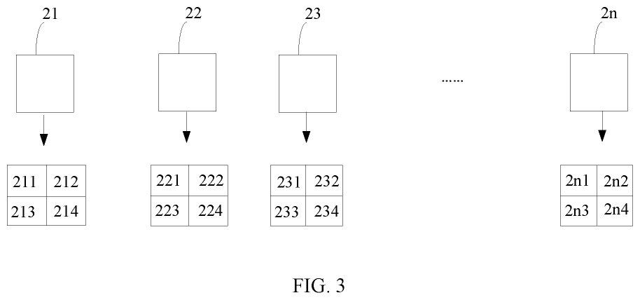

As shown in FIG. 3, the image frame 21 is assumed to be divided into four sub-images, such as sub-image 211, sub-image 212, sub-image 213, and sub-image 214. The image frame 22 is divided into four sub-images, such as sub-image 221, sub-image 222, sub-image 223, and sub-image 224. The image frame 23 is divided into 4 sub-images, such as sub-image 231, sub-image 232, sub-image 233, and sub-image 234. Generally, the first training video 20 includes n frames of images, and the last frame of images is represented as 2n. Each image frame in the first training video 20 can be decomposed into 4 sub-images until the image frame 2n is divided into 4 sub-images, such as sub-image 2n1, sub-image 2n2, sub-image 2n3, and sub-image 2n4. The above is only a schematic description and does not limit the number of sub-images that each image frame can be decomposed into, any number of sub-images may be used.

According to FIG. 3, the position of the sub-image 211 in the image frame 21, the position of the sub-image 221 in the image frame 22, and the position of the sub-image 231 in the image frame 23 are the same. Optionally, sub-images with a same position in several adjacent image frames in the first training video 20 is formed into a set. This set is referred to as a first time-space domain cube. The first time-space domain cube here is to distinguish it from a second time-space domain cube included in the subsequent second training video. For example, sub-images with a same position in every adjacent 5 frames of the first training video 20 is formed into a set. Sub-images 211, 221, 231, 241, and 251 from a same positions in image frames 21-25 form a first time-space domain cube 41. Sub-images 212, 222, 232, 242, and 252 from a same positions in image frames 21-25 form a first time-space domain cube 42. Sub-images 213, 223, 233, 243, and 253 from a same positions in image frames 21-25 form a first time-space domain cube 43. Sub-images 214, 224, 234, 244, and 254 from a same positions in image frames 21-25 form a first time-space domain cube 44. The above is only for illustrative purposes and does not limit the number of sub-images included in a first time-space domain cube.

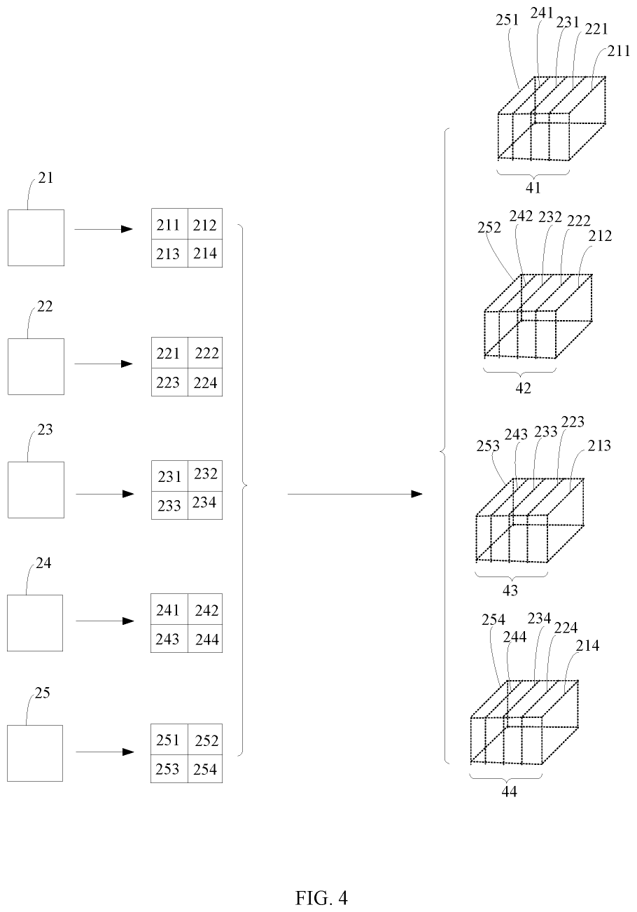

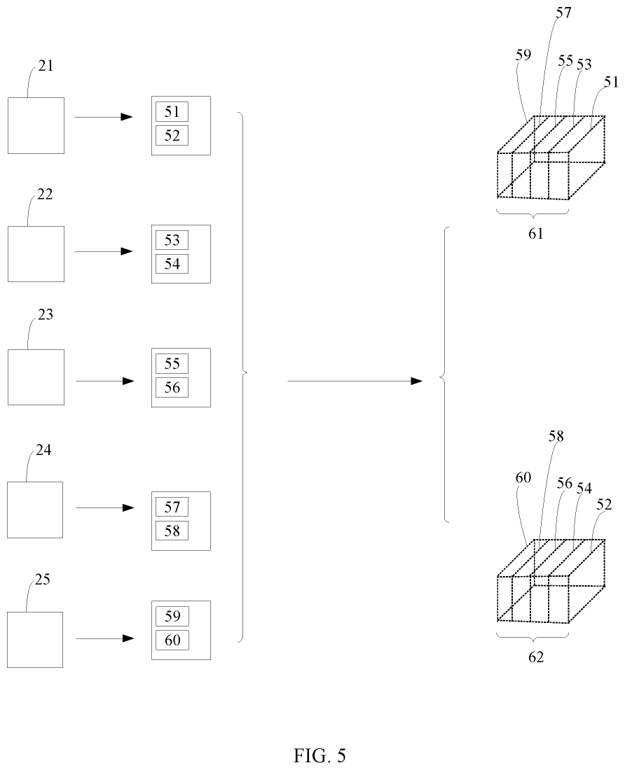

In certain other embodiments, each image frame in the first training video 20 may not be completely divided into a plurality of sub-images. As shown in FIG. 5, image frames 21-25 are five adjacent images, and only two two-dimensional rectangular blocks are intercepted from each image frame. For example, only two two-dimensional rectangular blocks are taken as the sub-image 51 and the sub-image 52 on the image frame 21. The entire image frame 21 is not divided into four sub-images as shown in FIG. 3 or FIG. 4. The above is only a schematic description, and the number of two-dimensional rectangular blocks intercepted from an image frame is not limited. Similarly, two two-dimensional rectangular blocks are intercepted from the image frame 22 as sub-image 53 and sub-image 54. Two two-dimensional rectangular blocks are intercepted from the image frame 23 as sub-image 55 and sub-image 56. Two two-dimensional rectangular blocks are intercepted from the image frame 24 as sub-image 57 and sub-image 58. Two two-dimensional rectangular blocks are intercepted from the image frame 25 as sub-image 59 and sub-image 60. Sub-images 51, 53, 55, 57, and 59 from a same position of image frames 21-25 form a first time-space domain cube 61. Sub-images 52, 54, 56, 58, and 60 from a same position of image frames 21-25 form a first time-space domain cube 62. The above is only for illustrative purposes and does not limit the number of sub-images included in a first time-space domain cube.

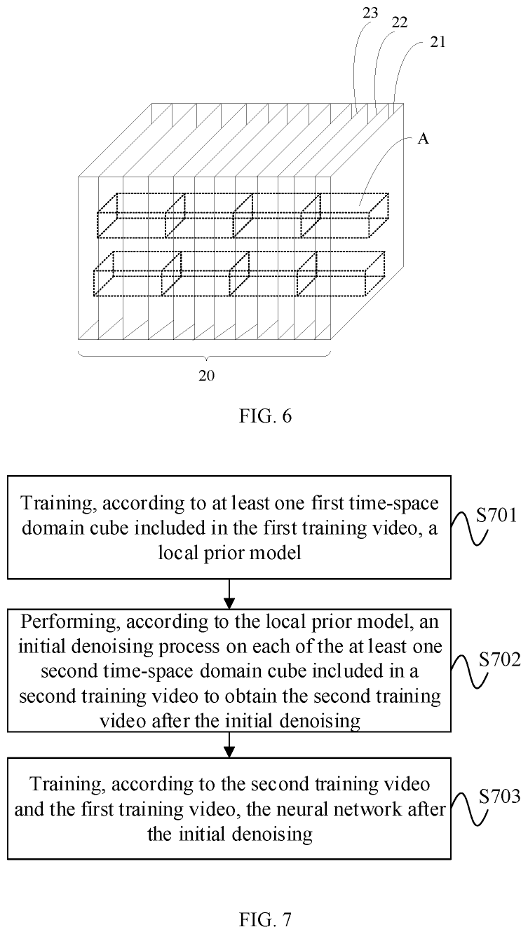

Similarly, the method for dividing the first time-space domain cube shown in FIG. 4 or FIG. 5 can divide a plurality of first time-space domain cubes from the first training video 20 shown in FIG. 2. As shown in FIG. 6, the first time-space domain cube A is only one of a plurality of first time-space domain cubes divided from the first training video 20. The number of first time-space domain cubes included in the first training video 20, the number of sub-images included in each first time-space domain cube, and the method for intercepting or dividing sub-images from image frames are not limited herein.

Generally, provided that the first training video 20 is represented as X, Xₜ represents a t-th frame image in the first training video 20, and 1≤t≤n. xₜ(i, j) represents a sub-image in the t-th frame image. (i, j) represents a position of the sub-image in the t-th frame image. In other words, xₜ(i, j) represents a two-dimensional rectangular block intercepted from the clean first training video 20. (i, j) represents a spatial domain index of the two-dimensional rectangular block. t represents a time-domain index of the two-dimensional rectangular block. Sub-images with a same position and a same size in several adjacent image frames in the first training video 20 is formed into a set. The set is referred to as a first time-space domain cube, which is expressed as the following formula (1):

Vₓ [symbol] {xₜ₀₋ₕ(i,j),K,xₜ₀(i,j),K,Xₜ₀₊ₕ(i,j)}={xₜ₀₊ₛ(i,j)}ₛ₌₋ₕ^{h} (1)

According to formula (1), the first time-space domain cube includes 2h+1 sub-images. That is, the sub-images with a same position and a same size in the adjacent 2h+1 image frames in the first training video 20 is formed into a set. The time-domain index t0−h, . . . , t0, . . . , t0+h and the spatial domain index (i, j) determine the position of the first time-space cube Vₓ in the first training video 20. According to different time-domain indexes and/or spatial domain indexes, a plurality of different first time-space domain cubes can be divided from the first training video 20.

The second time-space domain cube includes a plurality of second sub-images. The plurality of second sub-images are from a plurality of adjacent second video frames in the second training video. One second sub-image is from one second video frame. Each second sub-image has a same position in the second video frame. Provided that the second training video is represented as Y, Yₜ represents a t-th frame image in the second training video, yₜ(i,j) represents a sub-image in the t-th frame image. (i, j) represents a position of the sub-image in the t-th frame image. In other words, yₜ(i, j) represents a two-dimensional rectangular block intercepted from the second training video with noise added. (i, j) represents a spatial domain index of the two-dimensional rectangular block. t represents the time-domain index of a two-dimensional rectangular block. Sub-images with a same position and a same size in several adjacent image frames in the second training video is formed into a set. The set is referred to as a second time-space domain cube. The division principle and process of the second time-space domain cube are consistent with the division principle and process of the first time-space domain cube.

Specifically, the video processing device trains, according to at least one first time-space domain cube included in the first training video and at least one second time-space domain cube included in the second training video, the neural network. The process of training the neural network will be described in detail in subsequent embodiments.

S102: performing a denoising processing on the first video by using the neural network to generate a second video.

The video processing device inputs the first video, that is, the original video with noise, into a previously trained neural network, and uses the neural network to a perform denoising processing on the first video. That is, the noise in the first video is removed by the neural network to obtain a clean second video.

S103: outputting the second video after neural network processing.

The video processing device further outputs a clean second video. For example, if the first video is a video taken by a shooting device equipped with a UAV. The video processing device is set on the UAV. The first video can be converted into a clean second video after being processed by the video processing device. The UAV can further send the clean second video to the ground station through the communication system for users to watch.

According to the disclosed embodiments, the original first video with noise is inputted to a neural network that is trained in advance. The neural network is obtained by training at least one first time-space domain cube included in a clean first training video and at least one second time-space domain cube included in a second training video with noise. The first video through the neural network is denoised to generate a second video. Compared with the video denoising method based on motion estimation, the video processing method provided in the present disclosure improves the computational complexity of video denoising. The video processing method provided in the present disclosure improves the video denoising effect compared with the video denoising method without motion estimation.

FIG. 7 illustrates a flow chart of another exemplary video processing method consistent with various disclosed embodiments of the present disclosure. As shown in FIG. 7, based on the embodiment shown in FIG. 1, before inputting a first video to a neural network in S101, the video processing method further includes: training, according to the first training video and the second training video, the neural network. Specifically, training, according to the first training video and the second training video, the neural network includes the following steps.

S701: training, according to at least one first time-space domain cube included in the first training video, a local prior model.

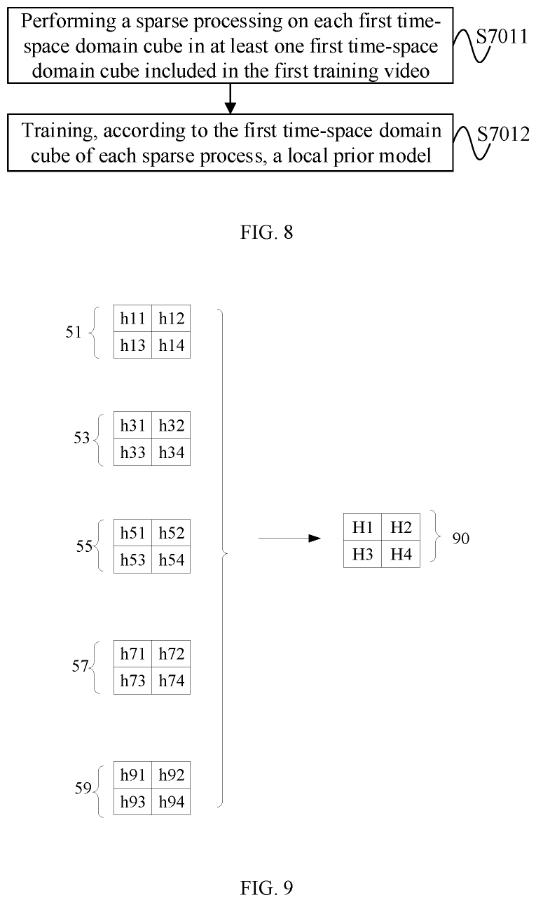

Specifically, training, according to at least one first time-space domain cube included in the first training video, a local prior model in S701 includes S7011 and S7012 shown in FIG. 8.

S7011: performing a sparse processing on each first time-space domain cube in at least one first time-space domain cube included in the first training video.

Specifically, performing the sparse processing on each first time-space domain cube in at least one first time-space domain cube included in the first training video includes: determining, according to a plurality of first sub-images included in the first time-space domain cube, a first mean image, a pixel value of each position in the first mean image being an average of pixel values of the plurality of first sub-images at the position; and subtracting the pixel value of a position in the first mean image from a pixel value of each first sub-image in the plurality of first sub-images included in the first time-space domain cube at the position.

As shown in FIG. 5, sub-images 51, 53, 55, 57, and 59 from a same positions of the image frames 21-25 form a first time-space domain cube 61. Taking the first time-space domain cube 61 as an example, the first time-space domain cube 61 includes the sub-images 51, 53, 55, 57, and 59. Since the sub-images 51, 53, 55, 57, and 59 have a same size, they are all assumed to be 2*2. The assumption is for illustrative purposes only, and the size of each sub-image is not limited. That is, the sub-images 51, 53, 55, 57, and 59 are two-dimensional rectangular blocks of two rows and two columns respectively.

As shown in FIG. 9, it is assumed that pixel values of the four pixels of the sub-image 51 are h11, h12, h13, and h14, respectively; pixel values of the four pixels of the sub-image 53 are h31, h32, h33, and h34, respectively; pixel values of the 4 pixels of the image 55 are h51, h52, h53, and h54, respectively; pixel values of the 4 pixels of the sub-image 57 are h71, h72, h73, and h74; and pixel values of the 4 pixels of the sub-image 59 are h91, h92, h93, h94. The average value of the pixel values in the first row and first column of the sub-images 51, 53, 55, 57, and 59 is calculated to be H1. That is, the average value of h11, h31, h51, h71, h91 is calculated to be H1. Similarly, the average value of the pixel values in the first row and second column of the sub-images 51, 53, 55, 57, and 59 is calculated to be H2. That is, the average value of h12, h32, h52, h72, h92 is H2. The average value of the pixel values in the second row and first column of the sub-images 51, 53, 55, 57, and 59 is calculated to be H3. That is, the average value of h13, h33, h53, h73, h93 is H3. The average value of the pixel values in the second row and second column of the sub-images 51, 53, 55, 57, and 59 is calculated to be H4. That is, the average value of h14, h34, h54, h74, h94 is H4. H1, H2, H3, H4 constitute a first mean image 90. That is, a pixel value at each position in the first mean image 90 is an average of the pixel values of the sub-images 51, 53, 55, 57, and 59 at a same position.

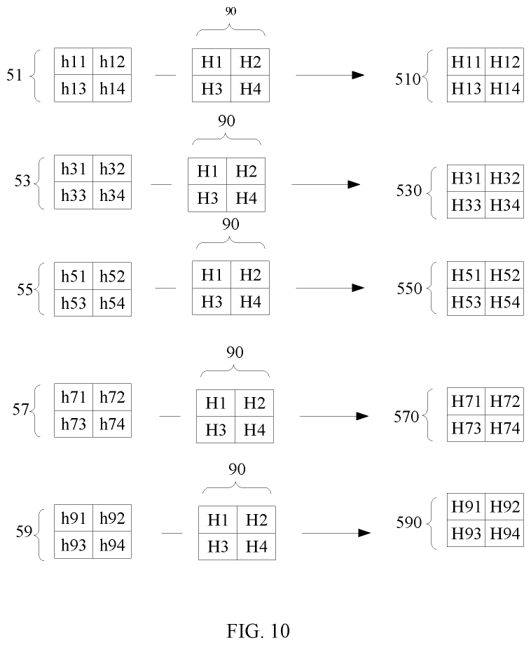

Further, as shown in FIG. 10, a pixel value of a same position in the first mean image 90 is subtracted from a pixel value of each position in the sub-image 51 to obtain a new sub-image 510. That is, h11 of the sub-image 51 is subtracted from H1 of the first mean image 90 to obtain H11. h12 of the sub-image 51 is subtracted from H1 of the first mean image 90 to obtain H12. h13 of the sub-image 51 is subtracted from the first mean image 90 to obtain H13. h14 of the sub-image 51 is subtracted from H4 of the first mean image 90 to obtain H14. H11, H12, H13, H14 form a new sub-image 510. Similarly, a pixel value of each position in the sub-image 53 is subtracted from a pixel value of a same position in the first mean image 90 to obtain a new sub-image 530. The sub-image 530 includes pixel values H31, H32, H33, and H34. A pixel value of each position in the sub-image 55 is subtracted from a pixel value of a same position in the first mean image 90 to obtain a new sub-image 550. The sub-image 550 includes pixel values H51, H52, H53, and H54. A pixel value of each position in the sub-image 57 is subtracted from a pixel value of a same position in the first mean image 90 to obtain a new sub-image 570. The sub-image 570 includes pixel values H71, H72, H73, and H74. A pixel value of each position in the sub-image 59 is subtracted from a pixel value of a same position in the first mean image 90 to obtain a new sub-image 590. The sub-image 590 includes pixel values H91, H92, H93, and H94.

As shown in FIG. 5, the sub-images 51, 53, 55, 57, and 59 are respectively from adjacent image frames 21-25. A correlation or similarity between adjacent image frames is strong. As shown in FIG. 9, the first mean image 90 is calculated from the sub-images 51, 53, 55, 57, and 59. As shown in FIG. 10, each of the sub-images 51, 53, 55, 57, 59 is subtracted from the first mean image 90 to obtain sub-images 510, 530, 550, 570, and 590. The sub-images 510, 530, 550, 570, and 590 have low correlation or similarity. The time-space domain cube composed of sub-images 510, 530, 550, 570, and 590 has stronger sparsity than the first time-space domain cube 61 composed of sub-images 51, 53, 55, 57, 59. That is, the time-space domain cube composed of the sub-images 510, 530, 550, 570, and 590 is a first time-space domain cube after the first time-space domain cube 61 is sparsely processed.

As shown in FIG. 6, the first training video 20 includes a plurality of first time-space domain cubes, and each of the first time-space domain cubes needs to be sparsely processed. Specifically, the principle and process of performing sparse processing on each of the first time-space-domain cubes in the plurality of first time-space-domain cubes are consistent with the principle and process of performing sparse processing on the first time-space domain cube 61.

Generally, the first time-space domain cube Vₓ represented by formula (1) includes 2h+1 sub-images. The first mean image determined from the 2h+1 sub-images included in the first time-space domain cube Vₓ is expressed as μ(i, j). The calculation formula of μ(i, j) is shown in the following formula (2):

$$μ ( i , j ) = \frac{1}{2 h + 1} {\sum }_{s = - h}^{h} \{ {x}_{t 0 + s} ( i , j ) \} \qquad ( 2 )$$

The time-space domain cube obtained by sparsely processing the first time-space domain cube Vₓ is expressed as V̅ₓ̅. V̅ₓ̅ can be expressed as formula (3):

V̅ₓ̅={x̅ₜ₀₊ₛ(i,j)}ₛ₌₋ₕ^{h}={xₜ₀₊ₛ(i,j)−μ(i,j)}ₛ₌₋ₕ^{h} (3)

S7012: training, according to the first time-space domain cube of each sparse process, a local prior model.

Since V̅ₓ is more sparse than Vₓ, it is easier to model the first time-space domain cube after each sparse processing in the first training video 20. Specifically, after each sparse processing in the first training video 20, each two-dimensional rectangular block in the first time-space domain cube forms a column vector. For example, the time-space domain cube formed by the sub-images 510, 530, 550, 570, and 590 is a sparsely processed first time-space domain cube in the first training video 20. The 4 pixel values of the sub-images 510, 530, 550, 570, and 590 respectively form a 4*1 column vector to obtain 5 4*1 column vectors. Similarly, in the first training video 20, after a sparse processing, each of other two-dimensional rectangular blocks in the first time-space domain cube forms a column vector. A Gaussian Mixture Model (GMM) is further used to model the column vector corresponding to each sparsely processed first time-space domain cube in the first training video 20 to obtain a local prior model. The local prior model is specifically a Local Volumetric Prior (LVP) model. The local prior model simultaneously constrains, after a same sparse processing, all two-dimensional rectangular blocks in the first spatiotemporal cube belong to a same Gaussian class, to obtain the likelihood function P(V̅ₓ̅) shown in the following formula (4):

P(V̅ₓ̅)=Σₖ₌₁^{K}πₖΠₛ₌₋ₕ^{h}N(x̅ₜ₀₊ₛ(i,j)\μₖ,Σₖ) (4)

K represents the number of Gaussian classes. k represents a k-th Gaussian class. πₖ represents a weight of the k-th Gaussian class. μₖ represents a mean of the k-th Gaussian class. Σₖ represents a covariance matrix of the k-th Gaussian class. N represents a probability density function.

Further, singular value decomposition is performed on the covariance matrix Σₖ of each Gaussian class to obtain an orthogonal dictionary Dₖ. The relationship between the orthogonal dictionary Dₖ and the covariance matrix Σₖ is shown in formula (5):

Σₖ=DₖΛₖDₖ^{T} (5)

The orthogonal dictionary Dₖ is composed of the eigenvectors of the covariance matrix Σₖ and Λₖ represents the eigenvalue matrix.

S702: Performing, according to the local prior model, an initial denoising process on each of the at least one second time-space domain cube included in a second training video to obtain the second training video after the initial denoising.

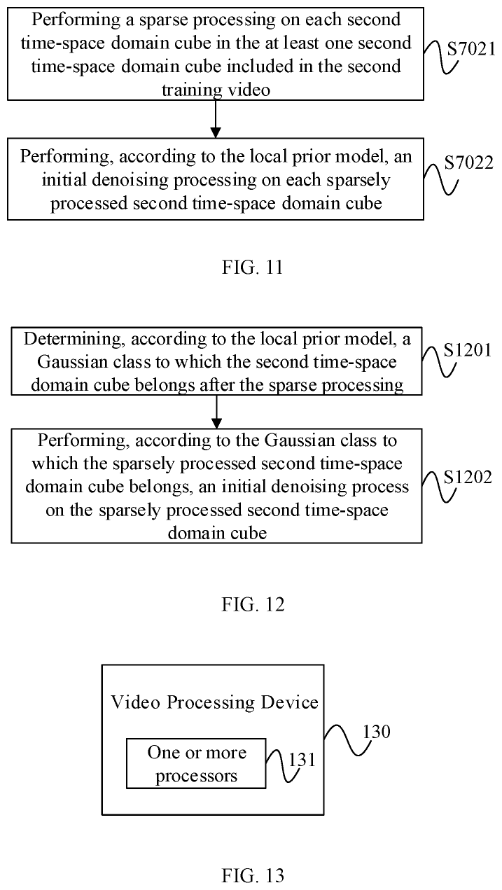

Specifically, in S702, performing, according to the local prior model, the initial denoising processing on each of at least one second time-space domain cube included in the second training video, includes S7021 and S7022 shown in FIG. 11.

S7021: performing a sparse processing on each second time-space domain cube in the at least one second time-space domain cube included in the second training video.

Specifically, performing the sparse processing on each second time-space domain cube in the at least one second time-space domain cube included in the second training video includes: determining, according to a plurality of second sub-images included in the second time-space domain cube, a second mean image, a pixel value of each position in the second mean image being an average of pixel values of the plurality of second sub-images at the position; and subtracting a pixel value of a position in the second mean image from a pixel value of each second sub-image in the plurality of first sub-images included in the first time-space domain cube at the position.

Provided that the second training video is represented as Y, Yₜ represents a t-th frame image in the second training video, yₜ(i, j) represents a sub-image in the t-th frame image. j) represents a position of the sub-image in the t-th frame image. In other words, yₜ(1, j) represents a two-dimensional rectangular block taken from the second training video with noise added. j) represents a spatial domain index of a two-dimensional rectangular block. t represents a time-domain index of a two-dimensional rectangular block.

Sub-images with a same position and a same size in several adjacent image frames in the second training video is formed into a set. The set is referred to as a second time-space domain cube V_{y}. The second training video Y can be divided into a plurality of second time-space domain cubes V_{y}. The division principle and process of a second time-space domain cube are consistent with the division principle and process of a first time-space domain cube. A second time-space domain cube can be expressed as the following formula (6):

V_{y} [symbol] {yₜ₋ₗ(i,j),K,yₜ(i,j),K,yₜ₊ₗ(i,j)}={yₜ₊ₛ(i,j)}ₛ₌₋ₗ^{l} (6)

The second time-space domain cube V_{y} includes 2l+1 sub-images, and the second mean image of the 2l+1 sub-images is expressed as η(i, j). The calculation formula of η(i, j) is shown in the following formula (7):

$$η ( i , j ) = \frac{1}{2 l + 1} {\sum }_{s = - l}^{l} \{ {y}_{t + s} ( i , j ) \} \qquad ( 7 )$$

The second time-space domain cube obtained after a further sparse processing on the second time-space domain cube V_{y} is expressed as V̅_{y}, which can be expressed as formula (8):

V̅_{y}={y̅ₜ₊ₛ(i,j)}ₛ₌₋ₗ^{l}={yₜ₊ₛ(i,j)−η(i,j)}ₛ₌₋ₗ^{l} (8)

The second time-space domain cube V̅_{y} obtained after a sparse processing has a stronger sparsity than the second time-space domain cube V̅_{y}. Since the second training video Y can be divided into a plurality of second time-space domain cubes V the sparse processing of each second time-space domain cube V_{y} can use the method of formula (7) and formula (8).

S7022: performing, according to the local prior model, an initial denoising processing on each sparsely processed second time-space domain cube.

Specifically, according to the local prior model determined in S7012, an initial denoising process is performed on each sparsely processed second time-space domain cube to obtain a second training video after the initial denoising.

S703. training, according to the second training video and the first training video, the neural network after the initial denoising.

Specifically, training, according to the second training video and the first training video after the initial denoising, the neural network includes: training the neural network by using the second training video after the initial denoising as training data and using the first training video as a label. Optionally, the neural network trained by using the second training video after the initial denoising as training data and the first training video as a label is a deep neural network.

In one embodiment, a local prior model is trained by using at least one first time-space domain cube included in the clean first training video. According to the trained local prior model, an initial denoising is processed on each second time-space domain cube in at least one second time-space domain cube included in the second training video with noise. A second training video after the initial denoising is obtained. The second training video after the initial denoising is used as training data. The clean first training video is used as the label to train the neural network. The neural network is a deep neural network, which can improve the denoising effect of noisy videos.

FIG. 12 illustrates a flow chart of still another exemplary video processing method consistent with various disclosed embodiments of the present disclosure. As shown in FIG. 12, based on the embodiment shown in FIG. 7, in S7022, performing, according to a local prior model, an initial denoising processing on each sparsely processed second time-space domain cube may include the following steps.

S1201: determining, according to the local prior model, a Gaussian class to which the second time-space domain cube belongs after the sparse processing.

S1202: performing, according to the Gaussian class to which the sparsely processed second time-space domain cube belongs, an initial denoising process on the sparsely processed second time-space domain cube.

Specifically, according to the likelihood function P(V̅ₓ̅) shown in formula (4), which Gaussian class in the mixed Gaussian model the obtained second time-space domain cube V̅_{y} after the sparse processing belongs to is determined. Because the second time-space domain cubes V̅_{y} obtained after a sparse processing can be multiple, the Gaussian class to which each V̅_{y} belongs is determined from the likelihood function P(V̅ₓ̅) shown in formula (4).

Specifically, performing, according to the Gaussian class to which the second time-space domain cube after the sparse processing belongs, by using a weighted sparse coding method, an initial denoising processing on the sparsely processed second time-space domain cube, includes the following S12021 and S12022:

S12021: determining, after the sparse processing, according to the Gaussian class to which the second time-space domain cube belongs, the dictionary and eigenvalue matrix of the Gaussian class.

S12022: performing, according to the dictionary and the eigenvalue matrix of the Gaussian class, an initial denoising processing on the sparsely processed second time-space domain cube. Determining, after the sparse processing, according to the Gaussian class to which the second time-space domain cube belongs, the dictionary and eigenvalue matrix of the Gaussian class, includes: performing a singular value decomposition on the covariance matrix of the Gaussian class to obtain a dictionary and eigenvalue matrix of the Gaussian class.

Provided that the second time-space domain cube V̅_{y} obtained after a sparse processing belongs to the k-th first Gaussian class in the mixed Gaussian model, according to the singular value decomposition of the covariance matrix Σₖ of the k-th Gaussian class by using the above formula (5), the orthogonal dictionary and the eigenvalue matrix of the k-th Gaussian class are determined.

Performing, according to the dictionary and eigenvalue matrix of the Gaussian class, by using a weighted sparse coding method, the initial denoising processing on the sparsely processed second time-space domain cube includes: determining, according to the eigenvalue matrix, a weight matrix; performing, according to a dictionary and the weight matrix of the Gaussian class, by using a weighted sparse coding method, the initial denoising processing on the sparsely processed second time-space domain cube.

Further, a weight matrix W is determined from the eigenvalue matrix Λₖ. Taking a sub-image y̅ₜ̅(i, j) in the second time-space space cube V̅_{y} after a sparse processing as an example, according to the orthogonal dictionary Dₖ and the weight matrix W of the k-th Gaussian class, by using a weighted sparse coding method, the method of performing an initial denoising processing is as formula (9) and formula (10):

$$\begin{matrix}\hat{\overline{x}} = {argmin}_{\overline{x}} {‖ {\overline{y}}_{t} ( i , j ) - \overline{x} ‖}_{2}^{2} + {‖ {W}^{T} α ‖}_{1} & ( 9 ) \\ s . t . \overline{x} = {D}_{k} α & ( 10 )\end{matrix}$$

x̅ represents a required sub-images after initial denoising of y̅ₜ(i, j), and

$$\hat{\overline{x}}$$

represents an estimated value of x̅. Further, by adding a second mean image η(i, j) on the basis of

$$\hat{\overline{x}} ,$$

a sub-image can be obtained by performing an initial denoising processing. yₜ(i, j) is a sub-image in the second time-space domain cube V_{y}. y̅ₜ(i,j) is a sub-image corresponding to the second time-space domain cube after subtracting the second time-space cube V_{y}, that is, yₜ(i, j) minus η(i, j) to get y̅ₜ(i, j). When the estimated value

$$\hat{\overline{x}}$$

of the sub-image after the initial denoising process on y̅ₜ(i, j) is calculated, on the basis of

$$\hat{\overline{x}} ,$$

the second average image η(i, j) is added to the basis of to obtain the sub-image after the initial denoising process of yₜ(i, j). Similarly, the sub-images after initial denoising processing for each sub-image in the second time-space cube V_{y} can be calculated. Since the second training video Y can be divided into multiple second time-space domain cubes V_{y}, the method described above can be used to perform an initial denoising processing on each sub-image in each of the multiple second time-space domain cubes V_{y}, thereby getting the second training video X̅ₜ after the initial denoising. In the second training video X̅ₜ after the initial denoising, a large amount of noise is suppressed.

In one embodiment, in order to learn the global time-space structure information of a video, a neural network with a receptive field size of 35*35 is designed. The input of the neural network is a middle frame Xₜ₀ of adjacent frames {\hat{X}ₜ₀₊ₛ}ₛ₌₋ₕ^{h} of the second training video \hat{X}ₜ after the initial denoising. Since the size of the 3*3 convolution kernel has been widely moved in the neural network, a 3*3 convolution kernel can be used, and a 17-layer network structure is designed. In the first layer of the network, since the input is a plurality of frames, 64 3*3*(2h+1) convolution kernels can be used. In the last layer of the network, in order to reconstruct an image, a 3*3*64 convolution layer can be used. The middle 15 layers of the network can use 64 3*3*64 convolution layers. A loss function of the network is shown in the following formula (11):

$$1 ( Θ ) = \frac{1}{2} {\sum }_{t 0} {‖ F ( {\{ {\hat{X}}_{t 0 + s} \}}_{s = - h}^{h} : Θ ) - ( {\hat{X}}_{t 0} - {X}_{t 0} ) ‖}_{F}^{2} \qquad ( 11 )$$

F represents a neural network. Parameter Θ can be calculated by minimizing the loss function to determine the neural network F.

Optionally, the present disclosure uses a linear rectification function (ReLU) as the non-linear layer and adds a normalization layer between the convolution layer and the non-linear layer.

In one embodiment, a local prior model is used to determine, after a sparse processing, the Gaussian class to which the second time-space domain cube belongs. According to the Gaussian class to which the sparsely processed second time-space domain cube belongs, by using a weighted sparse coding method, an initial denoising on the sparsely processed second time-space domain cube is performed, to implement a local time-space prior denoising method of deep neural network without motion estimation is implemented.

FIG. 13 illustrates a flow chart of a video processing device consistent with various disclosed embodiments of the present disclosure. As shown in FIG. 13, the video processing device 130 includes one or more processors 131, which work individually or in cooperation. The one or more processors 131 is used for: inputting a first video into a neural network, a training set of the neural network including a first training video and a second training video, the first training video including at least one first time-space domain cube, the second training video including at least one second time-space domain cube; performing a denoising processing on the first video by using the neural network to generate a second video; and outputting the second video.

Optionally, the first training video is a noise-free video, and the second training video is a noisy video.

The specific principle and implementation of the video processing device provided by one embodiment of the present disclosure are similar to the embodiments shown in FIG. 1. The video processing device includes one or more processors, individually or in cooperation, configured to perform: providing a neural network trained based on a training set of the neural network having a first training video and a second training video, the first training video including at least one first time-space domain cube, the second training video including a first training video at least one second time-space domain cube; inputting a first video into a neural network, the first video containing certain noise; performing a denoising processing on the first video by using the neural network to generate a second video, the second video being the first video with the certain noise substantially removed; and outputting the second video.

In one embodiment, the original first video with noise is inputted to a neural network that is trained in advance. The neural network is obtained by training at least one first time-space domain cube included in a clean first training video and at least one second time-space domain cube included in a noise-enhanced second training video. The first video through the neural network is denoised to generate a second video. Compared with the video denoising method based on motion estimation, the video processing method provided in the present disclosure improves the computational complexity of video denoising. The video processing method provided in the present disclosure improves the video denoising effect compared with the video denoising method without motion estimation.

Based on the technical solution provided in embodiments shown in FIG. 13, before one or more processors 131 input a first video to a neural network, the processor 131 is further used to: train, according to the first training video and the second training video, the neural network.

Specifically, when one or more processors 131 train the neural network according to the first training video and the second training video, the processor 131 is configured to perform: training, according to at least one first time-space domain cube included in the first training video, a local prior model; performing, according to the local prior model, an initial denoising process on each of the at least one second time-space domain cube included in the second training video to obtain a second training video after the initial denoising process; and training, according to the second training video and the first training video after the initial denoising process, the neural network.

Optionally, the first time-space domain cube includes a plurality of first sub-images. The plurality of first sub-images are from a plurality of adjacent first video frames in the first training video. One first sub-image being from one first video frame. Each first sub-image has a same position in the first video frame.

When the one or more processors 131 train a local prior model according to at least one first time-space domain cube included in the first training video, the processor is configured to perform: sparsely processing each first time-space domain cube in at least one first time-space domain cube included in the first training video; and training, according to the first time-space domain cube of each sparse process the local prior model. When the one or more processors 131 perform sparse processing on each of the at least one first time-space domain cube included in the first training video respectively, the one or more processors 131 are configured to perform: determining, according to a plurality of first sub-images included in the first time-space domain cube, a first mean image, a pixel value of each position in the first mean image being an average of pixel values of the plurality of first sub-images at the position; and subtracting the pixel value of a position in the first mean image from a pixel value of each first sub-image in the plurality of first sub-images included in the first time-space domain cube at the position.

Optionally, the second time-space domain cube includes a plurality of second sub-images. the plurality of second sub-images are from a plurality of adjacent second video frames in the second training video. One second sub-image being from one second video frame. Each second sub-image having a same position in the second video frame.

When one or more processors 131 respectively perform, according to the local prior model, an initial denoising process on each of at least one second time-space domain cube included in the second training video, the one or more processors 131 are configured to perform: sparsely processing each second time-space domain cube in the at least one second time-space domain cube included in the second training video; and performing, according to the local prior model, the initial denoising processing on each sparsely processed second time-space domain cube. When the one or more processors 131 sparse each of the at least one second time-space domain cube included in the second training video separately, the one or more processors 131 are configured to perform: determining, according to the plurality of second sub-images included in the second time-space domain cube, a second mean image, a pixel value of each position in the second mean image being an average value of pixel values of each second sub-image in the plurality of second sub-images at the position; and subtracting the pixel value of the position in the second mean image from a pixel value of each second sub-image in the plurality of second sub-images included in the second time-space domain cube at the position.

The specific principles and implementations of the video processing device provided by the present disclosure are similar to the embodiments shown in FIG. 7, FIG. 8, and FIG. 11.

In one embodiment, a local prior model is trained by using at least one first time-space domain cube included in the clean first training video. According to the trained local prior model, an initial denoising is processed on each second time-space domain cube in at least one second time-space domain cube included in the second training video with noise. A second training video after the initial denoising is obtained. The second training video after the initial denoising is used as training data. The clean first training video is used as the label to train the neural network. The neural network is a deep neural network, which can improve the denoising effect of noisy videos.

Based on the technical solutions provided by the embodiments shown in FIG. 7, FIG. 8, and FIG. 11, when the one or more processors 131 perform, according to the local prior model, an initial denoising processing on each second time-space space cube after a sparse processing, the one or more processors 131 are configured to perform: determining, according to the local prior model, a Gaussian class to which the second time-space domain cube belongs after the sparse processing; and performing, according to the Gaussian class to which the second time-space domain cube belongs after the sparse processing, by using a weighted sparse coding method, an initial denoising processing on the sparsely processed second time-space domain cube.

Specially, when the one or more processors 131 perform, according to the Gaussian class to which the second time-space domain cube belongs after the sparse processing, by using a weighted sparse coding method, an initial denoising processing on the sparsely processed second time-space domain cube, the one or more processors 131 are configured to perform: determining, according to the Gaussian class to which the second time-space domain cube after the sparse processing belongs, a dictionary and an eigenvalue matrix of the Gaussian class; and performing, according to the dictionary and an eigenvalue matrix of the Gaussian class, by using a weighted sparse coding method, the initial denoising processing on the sparsely processed second time-space domain cube.

When the one or more processors 131 determine, according to the Gaussian class to which the second time-space domain cube after the sparse processing belongs, the dictionary and the eigenvalue matrix of the Gaussian class, the one or more processors 131 are configured to perform: performing a singular value decomposition on the covariance matrix of the Gaussian class to obtain the dictionary and the eigenvalue matrix of the Gaussian class.

When the one or more processors 131 perform, according to the dictionary and the eigenvalue matrix of the Gaussian class, by using a weighted sparse coding method, the initial denoising processing on the sparsely processed second time-space domain cube, the one or more processors 131 are configured to perform: determining, according to the eigenvalue matrix, a weight matrix; and performing, according to the dictionary and the weight matrix of the Gaussian class, by using a weighted sparse coding method, the initial denoising processing on the sparsely processed second time-space domain cube.

Optionally, when the one or more processors 131 train, according to the second training video and the first training video after the initial denoising, the neural network, the one or more processors 131 are configured to perform: training the neural network by using the second training video after the initial denoising as training data and using the first training video as a label.

The specific principle and implementation of the video processing device provided by the present disclosure are similar to the embodiment shown in FIG. 12.

In one embodiment, when a second class of the Gaussian prior partial airspace model determination process after sparsely processing cube belongs. According to the Gaussian class to which the sparsely processed second time-space domain cube belongs, a weighted sparse coding method is used to perform an initial denoising on the sparsely processed second time-space domain cube. A local time-space and priori-assisted video denoising method for the deep neural network without motion estimation is implemented.

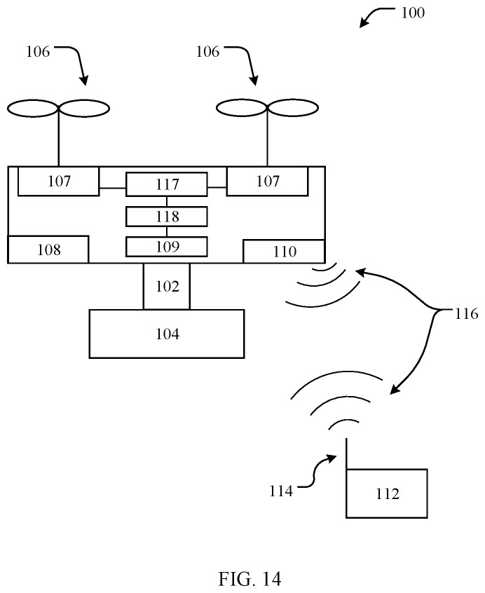

FIG. 14 illustrates a schematic diagram of an unmanned aerial vehicle consistent with various disclosed embodiments of the present disclosure. As shown in FIG. 14, the UAV 100 includes a fuselage, a power system, a flight controller 118, and a video processing device 109. The power system includes at least one of the following devices: a motor 107, a propeller 106, and an electronic speed control 117. The power system is mounted on the fuselage and is used to provide flight power. The flight controller 118 is communicatively connected to the power system and is used to control the UAV flight.

In addition, as shown in FIG. 14, the UAV 100 further includes: a sensing system 108, a communication system 110, a supporting device 102, and a photographing device 104. The supporting device 102 may be a gimbal. The communication system 110 may specifically include a receiver. The receiver is used to receive the wireless signal sent by an antenna 114 of the ground station 112. 116 represents an electromagnetic wave generated during the communication between the receiver and the antenna 114.

The video processing device 109 may perform video processing on the video captured by the photographic device 104. The video processing method is similar to the foregoing method embodiments. The specific principles and implementation methods of the video processing device 109 are similar to the embodiments described above.

In one embodiment, the original first video with noise is input to a neural network that is trained in advance. The neural network is obtained by training at least one first time-space domain cube included in a clean first training video and at least one second time-space domain cube included in a noise-enhanced second training video. The first video through the neural network is denoised to generate a second video. Compared with the video denoising method based on motion estimation, the video processing method provided in the present disclosure improves the computational complexity of video denoising. The video processing method provided in the present disclosure improves the video denoising effect compared with the video denoising method without motion estimation.

A computer-readable storage medium storing computer programs is provided in the present disclosure. when the computer program is executed by one or more processors, the following steps are implemented: inputting a first video into a neural network, a training set of the neural network including a first training video and a second training video, the first training video including at least one first time-space domain cube, the second training video including at least one second time-space domain cube; performing a denoising processing on the first video by using the neural network so as to generate a second video; and outputting the second video.

Optionally, before inputting the first video into the neural network, the computer-readable storage medium further trains, according to the first training video and the second training video, the neural network.

Optionally, training, according to the first training video and the second training video, the neural network includes: training, according to at least one first time-space domain cube included in the first training video, a local prior model; performing, according to the local prior model, an initial denoising process on each of the at least one second time-space domain cube included in the second training video to obtain a second training video after the initial denoising process; and training, according to the second training video and the first training video after the initial denoising process, the neural network.

Optionally, the first training video is a noiseless video, and the second training video is a noise video.

Optionally, the first time-space domain cube includes a plurality of first sub-images, the plurality of first sub-images being from a plurality of adjacent first video frames in the first training video, one first sub-image being from one first video frame, and each first sub-image having a same position in the first video frame.

Optionally, training, according to at least one first time-space domain cube included in the first training video, the local prior model includes: sparsely processing each first time-space domain cube in at least one first time-space domain cube included in the first training video; and training, according to the first time-space domain cube of each sparse process the local prior model.

Optionally, performing a sparse processing on each of the at least one first time-space domain cube included in the first training video separately includes: determining, according to a plurality of first sub-images included in the first time-space domain cube, a first mean image, a pixel value of each position in the first mean image being an average of pixel values of the plurality of first sub-images at the position; and subtracting the pixel value of a position in the first mean image from a pixel value of each first sub-image in the plurality of first sub-images included in the first time-space domain cube at the position.

Optionally, the second time-space domain cube includes a plurality of second sub-images. The plurality of second sub-images are from a plurality of adjacent second video frames in the second training video. One second sub-image is from one second video frame. Each second sub-image having a same position in the second video frame.

Optionally, performing, according to the local prior model, an initial denoising processing on each of at least one second time-space domain cube included in the second training video includes: sparsely processing each second time-space domain cube in the at least one second time-space domain cube included in the second training video; and performing, according to the local prior model, the initial denoising processing on each sparsely processed second time-space domain cube according.

Optionally, performing the sparse processing on each of the at least one second time-space domain cube included in the second training video separately includes: determining, according to the plurality of second sub-images included in the second time-space domain cube, a second mean image, a pixel value of each position in the second mean image being an average value of pixel values of each second sub-image in the plurality of second sub-images at the position; and subtracting the pixel value of the position in the second mean image from a pixel value of each second sub-image in the plurality of second sub-images included in the second time-space domain cube at the position.

Optionally, performing, according to the local prior model, an initial denoising process on each second time-space space cube after the sparse processing includes: determining, according to the local prior model, a Gaussian class to which the second time-space domain cube belongs after the sparse processing; and performing, according to the Gaussian class to which the second time-space domain cube belongs after the sparse processing, by using a weighted sparse coding method, an initial denoising processing on the sparsely processed second time-space domain cube.

Optionally, performing, according to the Gaussian class to which the second time-space domain cube belongs after the sparse processing, the initial denoising processing on the sparsely processed second time-space domain cube by using a weighted sparse coding method includes: determining, according to the Gaussian class to which the second time-space domain cube after the sparse processing belongs, a dictionary and an eigenvalue matrix of the Gaussian class; and performing, according to the dictionary and an eigenvalue matrix of the Gaussian class, by using a weighted sparse coding method, the initial denoising processing on the sparsely processed second time-space domain cube.

Optionally, determining, according to the Gaussian class to which the second time-space domain cube after the sparse processing belongs, the dictionary and the eigenvalue matrix of the Gaussian class includes: performing a singular value decomposition on the covariance matrix of the Gaussian class to obtain the dictionary and the eigenvalue matrix of the Gaussian class.

Optionally, performing, according to the dictionary and the eigenvalue matrix of the Gaussian class, by using a weighted sparse coding method, the initial denoising processing on the sparsely processed second time-space domain cube includes: determining, according to the eigenvalue matrix, a weight matrix; and performing, according to the dictionary and the weight matrix of the Gaussian class, by using a weighted sparse coding method, the initial denoising processing on the sparsely processed second time-space domain cube.

Optionally, training, according to the second training video and the first training video after the initial denoising, the neural network includes: training the neural network by using the second training video after the initial denoising as training data and using the first training video as a label.

In several embodiments provided by the present disclosure, the disclosed apparatus and methods may be implemented in other ways, and the device embodiments described above are merely exemplary. The division of the unit is only a kind of logical function division, and there may be another division manner in actual implementation. For example, multiple units or components can be combined or integrated into another system, or some features can be ignored or not implemented. The displayed or discussed mutual coupling or direct coupling or communication connection may be indirect coupling or communication connection through some interfaces, devices or units, which may be electrical, mechanical or other forms.

The units described as separate components may or may not be physically separated. Parts displayed as units may or may not be physical units. That is, parts can be located in one place or distributed across multiple network elements. According to actual needs, some or all of the units can be selected to achieve the purpose of the solution of one embodiment.

In addition, each functional unit in each embodiment of the present disclosure may be integrated into one processing unit, or each unit may exist separately physically, or two or more units may be integrated into one unit. The above integrated units can be implemented in the form of hardware, or in the form of hardware plus software functional units.

The above integrated unit implemented in the form of a software functional unit may be stored in a computer-readable storage medium. The above software functional unit is stored in a storage medium with several instructions for a computer device which may be a personal computer, a server, or a network device or a processor to execute some steps of the methods described in the embodiments of the present disclosure. The storage media include various media that can store program codes such as U disks, mobile hard disks, read-only memory (ROM), random access memory (RAM), magnetic disks, compact discs, etc.

Those skilled in the art can clearly understand that, for the convenience and brevity of description, take only the division of the functional modules described above for example. In practical applications, the above functions can be allocated by different functional modules as required. That is, the internal structure of a device is divided into different functional modules to complete all or part of the functions described above. For the specific working process of the device described above, reference may be made to the corresponding process in the foregoing method embodiment.

Finally, it should be noted that the above embodiments are only used to illustrate the technical solution of the present disclosure, and not to limit it. Although the present disclosure has been described in detail with reference to the above embodiments, those skilled in the art should understand that they can still modify the technical solutions described in the above embodiments, or equivalently replace some or all of its technical features. The modifications or replacements do not depart from the scope of the technical solutions of the embodiments of the present disclosure.

What is claimed is:

1. A video processing method, comprising:
providing a neural network trained based on a training set of the neural network having a first training video and a second training video, the first training video comprising at least one first time-space domain cube, the second training video comprising a first training video at least one second time-space domain cube;
inputting a first video into the neural network, the first video containing certain noise;
performing a denoising processing on the first video by using the neural network to generate a second video, the second video being the first video with the certain noise substantially removed; and
outputting the second video.

2. The method according to claim 1, wherein before inputting the first video into the neural network, the method further comprises:
training, according to the first training video and the second training video, the neural network, including:
training, according to at least one first time-space domain cube included in the first training video, a local prior model;
performing, according to the local prior model, an initial denoising process on each of the at least one second time-space domain cube included in the second training video to obtain a second training video after the initial denoising process; and
training, according to the second training video and the first training video after the initial denoising process, the neural network,
wherein the first training video is a noiseless video, and the second training video is a noisy video.

3. The method according to claim 2, wherein the first time-space domain cube comprises a plurality of first sub-images, the plurality of first sub-images are from a plurality of adjacent first video frames in the first training video, one first sub-image is from one first video frame, and each first sub-image has a same position in the first video frame.

4. The method according to claim 3, wherein training, according to at least one first time-space domain cube included in the first training video, the local prior model comprises:
sparsely processing each first time-space domain cube in at least one first time-space domain cube included in the first training video, including:
training, according to the first time-space domain cube of each sparse process, the local prior model;
determining, according to a plurality of first sub-images included in the first time-space domain cube, a first mean image, a pixel value of each position in the first mean image being an average of pixel values of the plurality of first sub-images at the position; and
subtracting the pixel value of a position in the first mean image from a pixel value of each first sub-image in the plurality of first sub-images included in the first time-space domain cube at the position.

5. The method according to claim 2, wherein the second time-space domain cube comprises a plurality of second sub-images, the plurality of second sub-images are from a plurality of adjacent second video frames in the second training video, one second sub-image is from one second video frame, and each second sub-image has a same position in the second video frame.

6. The method according to claim 5, wherein performing, according to the local prior model, an initial denoising processing on each of at least one second time-space domain cube included in the second training video comprises:
sparsely processing each second time-space domain cube in the at least one second time-space domain cube included in the second training video, including:
performing, according to the local prior model, the initial denoising processing on each sparsely processed second time-space domain cube;
determining, according to the plurality of second sub-images included in the second time-space domain cube, a second mean image, a pixel value of each position in the second mean image being an average value of pixel values of the plurality of second sub-images at the position; and
subtracting the pixel value of the position in the second mean image from a pixel value of each second sub-image in the plurality of second sub-images included in the second time-space domain cube at the position;
determining, according to the local prior model, a Gaussian class to which the second time-space domain cube belongs after the sparse processing; and
performing, according to the Gaussian class to which the second time-space domain cube belongs after the sparse processing, by using a weighted sparse coding method, an initial denoising processing on the sparsely processed second time-space domain cube;
determining, according to the Gaussian class to which the second time-space domain cube after the sparse processing belongs, a dictionary and an eigenvalue matrix of the Gaussian class; and
performing, according to the dictionary and the eigenvalue matrix of the Gaussian class, by using a weighted sparse coding method, the initial denoising processing on the sparsely processed second time-space domain cube.

7. The method according to claim 6, wherein determining, according to the Gaussian class to which the second time-space domain cube after the sparse processing belongs, the dictionary and the eigenvalue matrix of the Gaussian class comprises:
performing a singular value decomposition on the covariance matrix of the Gaussian class to obtain the dictionary and the eigenvalue matrix of the Gaussian class.

8. The method according to claim 6, wherein performing, according to the dictionary and the eigenvalue matrix of the Gaussian class, by using a weighted sparse coding method, the initial denoising processing on the sparsely processed second time-space domain cube comprises:
determining, according to the eigenvalue matrix, a weight matrix; and
performing, according to the dictionary and the weight matrix of the Gaussian class, by using a weighted sparse coding method, the initial denoising processing on the sparsely processed second time-space domain cube.

9. The method according to claim 2, wherein training, according to the second training video and the first training video after the initial denoising, the neural network comprises:
training the neural network by using the second training video after the initial denoising as training data and using the first training video as a label.

10. A video processing device, comprising:
one or more processors, individually or in cooperation, configured to perform:
providing a neural network trained based on a training set of the neural network having a first training video and a second training video, the first training video comprising at least one first time-space domain cube, the second training video comprising a first training video at least one second time-space domain cube;
inputting a first video into the neural network, the first video containing certain noise;
performing a denoising processing on the first video by using the neural network to generate a second video, the second video being the first video with the certain noise substantially removed; and
outputting the second video.

11. The video processing device according to claim 10, wherein before the one or more processors input the first video into the neural network, the one or more processors are configured to perform:
training, according to the first training video and the second training video, the neural network;
training, according to at least one first time-space domain cube included in the first training video, a local prior model;
performing, according to the local prior model, an initial denoising process on each of the at least one second time-space domain cube included in the second training video to obtain a second training video after the initial denoising process; and
training, according to the second training video and the first training video after the initial denoising process, the neural network,
wherein the first training video is a noiseless video, and the second training video is a noisy video.

12. The video processing device according to claim 11, wherein the first time-space domain cube comprises a plurality of first sub-images, the plurality of first sub-images are from a plurality of adjacent first video frames in the first training video, one first sub-image is from one first video frame, and each first sub-image has a same position in the first video frame.

13. The video processing device according to claim 12, wherein when the one or more processors train, according to at least one first time-space domain cube included in the first training video, the local prior model, the one or more processors are configured to perform:
sparsely processing each first time-space domain cube in at least one first time-space domain cube included in the first training video, including:
training, according to the first time-space domain cube of each sparse process, the local prior model;
determining, according to a plurality of first sub-images included in the first time-space domain cube, a first mean image, a pixel value of each position in the first mean image being an average of pixel values of the plurality of first sub-images at the position; and
subtracting the pixel value of a position in the first mean image from a pixel value of each first sub-image in the plurality of first sub-images included in the first time-space domain cube at the position.

14. The video processing device according to claim 13, wherein the second time-space domain cube comprises a plurality of second sub-images, the plurality of second sub-images are from a plurality of adjacent second video frames in the second training video, one second sub-image is from one second video frame, and each second sub-image has a same position in the second video frame.

15. The video processing device according to claim 14, wherein when the one or more processors perform, according to the local prior model, an initial denoising processing on each of at least one second time-space domain cube included in the second training video, the one or more processors are configured to perform:
sparsely processing each second time-space domain cube in the at least one second time-space domain cube included in the second training video, including:
performing, according to the local prior model, the initial denoising processing on each sparsely processed second time-space domain cube;
determining, according to the plurality of second sub-images included in the second time-space domain cube, a second mean image, a pixel value of each position in the second mean image being an average value of pixel values of the plurality of second sub-images at the position; and
subtracting the pixel value of the position in the second mean image from a pixel value of each second sub-image in the plurality of second sub-images included in the second time-space domain cube at the position;
determining, according to the local prior model, a Gaussian class to which the second time-space domain cube belongs after the sparse processing; and
performing, according to the Gaussian class to which the second time-space domain cube belongs after the sparse processing, by using a weighted sparse coding method, an initial denoising processing on the sparsely processed second time-space domain cube;
determining, according to the Gaussian class to which the second time-space domain cube after the sparse processing belongs, a dictionary and an eigenvalue matrix of the Gaussian class; and
performing, according to the dictionary and the eigenvalue matrix of the Gaussian class, by using a weighted sparse coding method, the initial denoising processing on the sparsely processed second time-space domain cube.

16. The video processing device according to claim 15, wherein when the one or more processors determine, according to the Gaussian class to which the second time-space domain cube after the sparse processing belongs, the dictionary and the eigenvalue matrix of the Gaussian class, the one or more processors are configured to perform:
performing a singular value decomposition on the covariance matrix of the Gaussian class to obtain the dictionary and the eigenvalue matrix of the Gaussian class.

17. The video processing device according to claim 16, wherein when the one or more processors performs, according to the dictionary and the eigenvalue matrix of the Gaussian class, by using a weighted sparse coding method, the initial denoising processing on the sparsely processed second time-space domain cube, the one or more processors are configured to perform:
determining, according to the eigenvalue matrix, a weight matrix; and
performing, according to the dictionary and the weight matrix of the Gaussian class, by using a weighted sparse coding method, the initial denoising processing on the sparsely processed second time-space domain cube.

18. The video processing device according to claim 17, wherein when the one or more processors train, according to the second training video and the first training video after the initial denoising, the neural network, the one or more processors are configured to perform:
training the neural network by using the second training video after the initial denoising as training data and using the first training video as a label.

19. An unmanned aerial vehicle, comprising a fuselage; a power system mounted on the fuselage for providing flight power; and a video processing device according to claim 10.

20. A non-transitory computer-readable storage medium storing computer-executable instructions executable by one or more processors to perform:
providing a neural network trained based on a training set of the neural network having a first training video and a second training video, the first training video comprising at least one first time-space domain cube, the second training video comprising a first training video at least one second time-space domain cube;
inputting a first video into the neural network, the first video containing certain noise;
performing a denoising processing on the first video by using the neural network to generate a second video, the second video being the first video with the certain noise substantially removed; and
outputting the second video.
